(19) United States
(12) Patent Application Publication
(10) Pub. No.: US 2006/0123116 A1
(43) Pub. Date: Jun. 8, 2006

(54) Service discovery using session initiating protocol (SIP)

(75) Inventors: Mahfuzur Rahman, South Brunswick, NJ (US); John Buford, Lawrenceville, NJ (US)

Correspondence Address: HARNESS, DICKEY & PIERCE, P.L.C., P.O. BOX 828, BLOOMFIELD HILLS, MI, 48303, US

(73) Assignee: Matsushita Electric Industrial Co., Ltd., Osaka (JP)

(21) Appl. No.: 11/002,738

(22) Filed: Dec. 2, 2004

(51) Int. Cl. H04Q 7/20

(52) U.S. Cl. 709/227

(57) ABSTRACT

One or more system components participate in a SIP-enabled service discovery protocol. Participation includes using SIP capability to publish, subscribe to, and/or notify of services using: (a) a service description formatted according to a predefined service discovery protocol; and/or (b) a service description query formatted according to the predefined service discovery protocol. The predefined service discovery protocol can be SLP. The system component can be a service providing device, a service subscribing device, and/or a network node. Service subscribing devices can use subscribe and notify components of a SIP event package to send service description queries and obtain service descriptions. Service providing devices can advertise service descriptions using the SIP publish method. Network nodes can propagate service advertisements downstream using the SIP publish method, and/or can inform subscribing devices of services using the notify component of the SIP event package.

### FIELD OF THE INVENTION

The present invention generally relates to service discovery systems and methods, and relates in particular to a service discovery mechanism for wide area networks using Session Initiation Protocol (SIP).

### BACKGROUND OF THE INVENTION

Over the last several years we have witnessed the proliferation of network-attached devices. As a consequence of this proliferation we have seen an enormous expansion of services provided by different service providers. In addition to supporting traditional services such as voice, fax, printing and so on, service providers are expanding the horizon by enabling services like video on demand, music on demand, and others. As this trend continues, it is essential to provide a means to find and make use of services available in a network. For example, consider a scenario where a user is in a conference room with an internet capable hand held device and it is connected to the wireless network provided by the conference. Assuming that the user would like to print a document. Unless the user knows that there is a printer in the conference room and the name and address of the printer, it would be very difficult to do so. But if the user has a technology that automatically detects the devices available in the network and the services provided by them, it would be very easy for the user to find a printer and print the document. Automatic service and device discovery provides this capability.

There are a number of technologies that have emerged over the past few years for automatic service discovery by different industries and standard forums. The discovery of services in an automated fashion is an essential part of current and future network infrastructure. Among the competing technologies, Service Location Protocol (SLP), Universal Plug and Play (UPnP), Jini, Salutations, and Service Discovery Protocol (SDP) of Bluetooth are showing significant promise. Service discovery is not only an important part of plug-and-play or support for SOHO (small office/home offices), it also has an ever-increasing impact on mobile and pervasive computing environments. Recently, Session Initiation Protocol (SIP) has gained a tremendous amount of popularity in the 3G infrastructures as a signaling protocol. However, SIP has not been designed for service discovery protocol.

Turning to FIG. 1, the Service Location Protocol (SLP) provides a scalable framework for the discovery and selection of network services. SLP is an IETF (Internet Engineering Task Force) based protocol that simplifies the discovery of network resources such as files systems, printers, web servers, fax machines, and others. SLP has been designed to serve enterprise networks with shared resources. However, SLP might not scale enough for the Internet environment for wide area service discovery. SLP defines three types of agents.

One type of agent defined by SLP is a User Agent (UA) 20. A UA 20 works on the user's behalf to establish contact with some service 22A or 22B via intranet 24. The UA 20 retrieves service information from the Service Agents 26A-26D or Directory Agents 28. The UA 20 issues a ‘Service Request’ (SrvRqst) on behalf of an application 30. Turning to FIG. 2, SLP allows a UA 20 to send a request directly to Service Agents 26E-26F. In this scenario, the message is a multicast message 32. The UA 20 receives a unicast ‘Service Reply’ (SrvRply) 34 specifying the location of all services 22A-22B in the network that satisfy the request.

Another type of agent defined by SLP is a Service Agent (SA). An SA works on the behalf of one or more services to advertise the services. Service Agents send register messages (SrvReg) containing all the services they advertise to Directory Agents described below, and receive acknowledgements in reply (SrvAck). These advertisements must be refreshed with the Directory Agents.

A further type of agent defined by SLP is a Directory Agent (DA). A DA collects together service advertisements in an intranet environment. It is used for scalability purposes. In a large network there might be one or more DAs. There are two ways by which a UA and an SA can discover a DA. Firstly, a UA and an SA can find a DA by issuing a multicast Service Request for the ‘Directory Agent’ service when they start up. Secondly, a UA and an SA can find a DA by listening for an unsolicited advertisement, which the DA can send infrequently.

SLP supports service browsing and string based querying for service attributes, which allow a UA to select the most appropriate services from among the available services in the network by using key words and attribute values. The keywords and attribute values can be combined into boolean expressions with the following operators: AND, OR, common operators (=, >, <, >=, <=) and substring matching. SLP uses service Uniform Resource Locators (URLs) for identifying a service type and address for a particular service. For example, “service:printer:Ipr/fhostname” is the service URL for a line printer service available at hostname. When a UA wants to receive a service handle for a particular service, it sends the Service Type and a string-based query for the desired attributes in a Service Requests. The returned reply contains the URL for the particular service type.

SLP is a lightweight protocol and has a leasing concept with a lifetime that defines how long a DA will store a service registration. DHCP options to configure SLP have already been defined. Also, SLP can work with LDAP (Light Weight Directory Access Protocols). However SLP does not scale beyond a single administrative domain for several reasons.

One reason SLP does not scale beyond a single administrative domain is that registrations of services from SA's to DA's are asynchronous, and the soft-state refresh interval is fixed (the recommended value is around three hours). As a result, if thousands of servers attempt to register, the DA may be swamped with bursts of messages. As the number of servers grows, this problem worsens.

Another reason SLP does not scale beyond a single administrative domain is that SA's must know the location of all DA's. In a small administrative domain, the task of obtaining and managing this knowledge is easy. However, in a wide area Internet, this task is virtually impossible. Having fixed tables of DA's does not scale well, and is not dynamic enough. Using the multicast searching technique causes an overload on the network, since the scope of such searches is necessarily unbounded. Having DA's advertise their presence works better, but still causes traffic. With fixed soft-state refresh intervals, the bandwidth used grows linearly with the number of DA's present in the network.

A further reason SLP does not scale beyond a single administrative domain is related to growth of numbers of servers and services. As the number of servers and services grow, the disk space required for a DA to store information about all of them is excessive. DA's must somehow be able to provide service location for only a subset of services.

Turning now to FIG. 3, Wide Area Service Discovery Protocol (WASRV) provides extensions to the Service Location Protocol (SLP), which allow service discovery in a wide area network 36. WASRV uses scalable wide area multicast messages to allow agents within an administrative domain to learn about services within other domains. The protocol also describes a new agent, the Brokering Agent (BA) 38, which is responsible for providing information about a particular set of services types. WASRV also introduces the term Service Location Protocol Domain (SLPD) 40A-40D. An SLPD is a collection of UA's, SA's, and DA's under the administration of a single authority.

The multicast extensions to SLP have support for both wide area service discovery and multicast based registrations within an SLPD. The idea is to define an entity in each SLP administrative domain to act as an Advertising Agent (AA) 42. The responsibility of an AA is to advertise a subset of services available within an SLPD to other SLPD's in the wide area network. An SA, DA, or BA within an SLPD can be configured to act as an AA, as with hybrid AA/BA 44. The role of a Brokering Agent (BA) in each SLPD is to join the wide area multicast group corresponding to the service types for which they wish to be brokered. As a consequence, BAs in each SLPD build up service databases of services located in remote SLPDs by selectively listening to multicast messages from other SLPD Ms. BAs also advertise these services to the local SLPD as if they were SAs in the local domain.

With WASRV architecture, a client can locate a service by using current SLP methods. The client first locates a DA in its domain. The client then sends out a request for a particular service to the DA. If the required service is within the domain, then the DA is able to resolve the request. If the DA cannot resolve the service request, it contacts the BA that is responsible for the particular service type, sends a query to that BA, and sends back the response to the client.

There are several unresolved issues with WASRV. Firstly, WASRV heavily relies on multicast messaging for service registrations. As multicast messages use User Datagram Protocol (UDP), the entire registration message needs to be fit within the path Maximum Transmission Unit (MTU); this need obtains unless WASLP provides a mechanism for breaking up messages into multiple packets of MTU size with a mechanism for reassembly of these packets at the receiving end. Secondly, wide area multicast is generally not yet available. Thirdly, the AAs need to be configured to determine which service descriptions are propagated between SLPDs. In the worst case, it is possible that the entire database is propagated.

Universal Plug and Play (UPnP) is a distributed open network architecture that uses Transmission Control Protocol/Internet Protocol (TCP/IP) and web technologies to provide seamless pervasive peer-to-peer connectivity among network devices. Microsoft has initiated a UPnP standardization process and the standard is still evolving. The ultimate goal of this standard is to enable the advertisement, discovery, and control of networked devices and services. Referring to FIG. 3, UPnP has six phases of operation.

Turning now to FIG. 4, UPnP includes several phases of operation, including initialization phases 46A-C, and operation phases 48A-C. Initialization phases include addressing phase 46A, service description phase 46B, and service discovery phase 46C. Operation phases include control phase 48A, eventing phase 48B, and presentation phase 48C. A UPnP device during initialization phases 46-50 needs to receive an IP address to interact with other UPnP devices or control points. There are several ways a UPnP device can acquire its IP address. One way to receive an IP address is to use a DHCP server and another alternative is to assign a static IP address. UPnP also has a feature that allows automatic assignment of an IP address for environments with little infrastructure, such as Home LAN. UPnP uses a protocol called Auto-IP to assign IP addresses automatically. These IP addresses are non-routable. Initially, when a device starts up, it tries to receive an IP address from a DHCP server and, in the absence of a DHCP server; an IP address is claimed automatically from a reserved range of addresses for the local network. A device claims an IP address from the reserved range of addresses and then uses an Address Resolution Protocol (ARP) request to see if anyone else has already claimed the address.

UPnP commonly uses Extensible Markup Language (XML) to describe devices' characteristics and functionalities. UPnP description documents use XML to describe root devices and all embedded devices and to indicate which services are provided by these devices. The UPnP standard defines a standard description template and it defines standard device types using this template. Vendors are also allowed to add their own extensions.

Turning now to FIG. 5, a device 50 and a control point 52 interact by exchanging information. First, the device 50 advertises its presence to the control point 52, which responds by getting the device description. Next, the control point 52 gets the service descriptions. Finally, the control point 52 invokes actions of the device 50.

Turning now to FIG. 6, the UPnP description document also describes the protocol a service speaks and it is used by control points to interact with the device. The UPnP protocol stack includes a UPnP protocol implementation Application Program Interface (API) 54, Simple Object Access Protocol (SOAP) 56, General Event Notification Architecture (GENA) 58, Simple Service Discovery Protocol (SSDP) 60, AUTO-IP 62, Hyper Text Transfer Protocol (HTTP) over TCP 64, HTTP over Unicast/Multicast UDP 66, ARP 68, TCP 70, and UDP 72. The interaction of a control point with a device is called an action and it usually uses calls similar to Remote Procedure Calls (RPC) using SOAP. For every action, zero or more parameters are specified, and these parameters are of a type either in or out. The type of parameter specifies a value when an RPC call is performed or supplied by the service when the RPC call is performed.

After obtaining an IP address, a device may advertise itself and its services to the control points and control points discover devices. A service is identified by service type and Unique Service Name (USN). UPnP uses SSDP to detect network services. SSDP is a distributed, decentralized discovery mechanism. It does not require a central server and it supports peer-to-peer service discovery. SSDP is a simple HTTP-based discovery solution. It uses HTTP over multicast and unicast UDP referred to as HTTPMU and HTTPU, respectively.

After obtaining an IP address, a device advertises itself and its services by sending out ssdp:alive multicast messages to control points. When a device leaves the network it announces its departure by sending ssdp:bye-bye multicast messages to the control points. A control point, if present, records these kind of announcements. Other devices might also be able to see the multicast advertisements and/or announcements. As these messages are sent by using UDP multicast and UDP is inherently unreliable, each message is sent multiple times in order to make sure that at least one of the messages reaches the control points or some other devices. UPnP can work with or without control points. When a new control point is added to the network, it sends a search message (ssdp:discover) which is basically a multicast UDP message. When a device receives this message it responds by sending a unicast response message.

UPnP uses SOAP as the control protocol. SOAP provides a means to bind together XML and HTTP in order to support web based messaging and a remote procedure call mechanism. Even though it is easy to bind SOAP with HTTP, SOAP can work on top of many different protocols, such as File Transfer Protocol (FTP), SIP, and others. In UPnP, each service element has a <controlURL>-an element that contains the URL where all the control messages for that particular service has to be sent. UPnP represents control as a collection of SOAP objects and their URLs in the XML file. To control a specific service or device, a SOAP message is sent to the SOAP control object at the specified URLs over HTTP.

UPnP also supports a mechanism that allows a control point to receive asynchronous notifications about state changes in UPnP services. UPnP uses GENA to achieve this goal. An event subscription URL is specified in the device description document for each service offered by a device. Any request to subscribe and unsubscribe to such service should be sent to that specific URL. GENA introduces three HTTP methods to provide subscription/notifications services: SUBSCRIBE; UNSUBSCRIBE; and NOTIFY. Each subscription is identified by a Subscription ID (SID). The SID is shared between the subscriber and the publisher. The messages exchanged for subscription, notifications or un-subscriptions are expressed using XML and formatted using GENA.

UPnP is designed for TCP/IP networks only, and in its current form it does not allow searches for services attributes. UPnP is supported by a large number of companies, which might make UPnP a successful approach in several years.

The LDAP was designed as a thin front end for accessing an X.500 database. Its applicability has grown. It is now a more general mechanism for both client and administrative access to distributed databases, X.500 or otherwise.

The main limitation of LDAP for wide area service location is its reliance on indexing of the database on a single key, and distribution of components of the database across the network based on that key. Usually, this key is related to some kind of organizational hierarchy. This unified organizational component makes LDAP databases ideal for things like yellow pages and white pages. However, in wide area service location, there is no single attribute upon which the database can be distributed. LDAP also requires a great deal of regularity in syntax and semantics in order to function properly. All cooperating databases and clients must use exactly the same schema. Furthermore, it is not feasible to store or search for entries for which the schema is not known a priori. This requirement for a priori knowledge is problematic for wide area service location, where many remote services are involved, and where the client may not know about the schema. By its nature, the directory supports lookup of entities well, but it supports wide area searches by ‘type’ poorly. Wide area service location must be more flexible, allowing more relaxed use of schema. Furthermore, the schema for any service must be extensible in a de-centralized manner. Even though LDAP requires a more robust solution to the problems of server discovery, LDAP could be used by clients to make requests of a wide area service location system

Session Initiation Protocol (SIP) is the standard Internet Engineering Task Force (IETF) signaling protocol used for setting up, controlling and tearing down “interactive communication sessions” with two or more participants. SIP sessions include, but are not limited to, multimedia sessions and telephone calls. On the other hand, SIP for Instant Messaging and Presence Leveraging Extensions (SIMPLE) is a set of extensions to SIP specifically to support instant messaging and presence. SIP is an application-layer, text-based, peer-to-peer protocol modeled after Hyper Text Transfer Protocol/Simple Mail Transfer Protocol (HTTP/SMTP) protocols. In other words, each SIP request is an attempt to invoke some methods on the called party similar to HTTP.

FIG. 7 shows a SIP-based Network Architecture. The main entities in the architecture are the SIP User Agent 84A-84C or SIP Client and the SIP Proxy/Redirect Server 86A-86C, which connect various domains 88A-88C via the Internet 90. The SIP Client or User Agent (UA) is an end system that acts on behalf of someone who wants to participate in an instant messaging and presence service. It contains a User Agent client (UAC) that initiates a request and a User Agent server (UAS) that answers the request. The presence of UAC and UAS enables peer-to-peer communication. The SIP Proxy/Redirect Server, after receiving a SIP request, determines the next hop server on the way to the destination and forwards the request to the next hop server. A redirect server, instead of forwarding the request to the next hop server, notifies the client to contact the next hop server. To redirect the client to the next hop server, a redirect server sends a redirection response to the client.

Event notification can be accomplished using SIP. The ability to request asynchronous notification of events proves useful in many types of SIP services for which cooperation between end-nodes is required. Examples of such services include automatic callback services (based on terminal state events), buddy lists (based on user presence events), message waiting indications (based on mailbox state change events), and service information of a service provider. SIP provides a way to define event packages so that these can be achieved.

The event notification mechanisms defined by SIP are not intended to be a general-purpose infrastructure for all classes of event subscription and notification. Meeting requirements for the general problem set of subscription and notification is far too complex for a single protocol. The goal is a SIP-specific framework for event notification which is not so complex as to be unusable for simple features, but which is still flexible enough to provide powerful services.

The general concept is that entities in the network can subscribe to resource or call state for various resources or calls in the network, and those entities (or entities acting on their behalf) can send notifications when those states change. FIG. 8 shows a typical message flow diagram for a SIP based subscription/notification mechanism. Therein, a subscriber 92 first sends a subscribe message to a notifier 94. The notifier responds by sending back a 200OK message, followed by a notify message. The subscriber 92 responds to the notify message by sending a 200OK message to the notifier 94.

SUBSCRIBE requests contain an “Expires” header (defined in SIP). This expires value indicates the duration of the subscription. In order to keep subscriptions effective beyond the duration communicated in the “Expires” header, subscribers need to refresh subscriptions on a periodic basis using a new SUBSCRIBE message on the same dialog as defined in SIP.

If no “Expires” header is present in a SUBSCRIBE request, the implied default is defined by the event package. 200-class responses to SUBSCRIBE requests also contain an “Expires” header. The period of time in the response may be shorter but must not be longer than specified in the request. The period of time in the response defines the duration of the subscription.

Identification of events is provided by three pieces of information: Request Uniform Resource Identifier (URI), Event Type, and (optionally) message body. The Request URI of a SUBSCRIBE request, most importantly, contains enough information to route the request to the appropriate entity per the request routing procedures outlined in SIP. It also contains enough information to identify the resource for which event notification is desired, but not necessarily enough information to uniquely identify the nature of the event. For example, “sip:directoryagent@home.com” can be an appropriate URI to subscribe to for service information for the services offered by home.com.

Subscribers must include exactly one “Event” header in SUBSCRIBE requests, indicating to which event or class of events they are subscribing. The “Event” header contains a token, which indicates the type of state for which a subscription is being requested. This token is registered with the Internet Assigned Numbers Authority (IANA), and corresponds to an event package, which further describes the semantics of the event or event class.

NOTIFY messages are sent to inform subscribers of changes in state to which the subscriber has a subscription. Subscriptions are typically put in place using the SUBSCRIBE method; however, it is possible that other means have been used.

If any non-SUBSCRIBE mechanisms are defined to create subscriptions, it is the responsibility of the parties defining those mechanisms to ensure that correlation of a NOTIFY message to the corresponding subscription is possible. Designers of such mechanisms are also warned to make a distinction between sending a NOTIFY message to a subscriber who is aware of the subscription, and sending a NOTIFY message to an unsuspecting node. The latter behavior is invalid, and MUST receive a “481 Subscription does not exist” response (unless some other 400- or 500-class error code is more applicable). In other words, knowledge of a subscription must exist in both the subscriber and the notifier to be valid, even if installed via a non-SUBSCRIBE mechanism.

A NOTIFY does not terminate its corresponding subscription; in other words, a single SUBSCRIBE request may trigger several NOTIFY requests.

As in SUBSCRIBE requests, NOTIFY “Event” headers contain a single event package name for which a notification is being generated. The package name in the “Event” header MUST match the “Event” header in the corresponding SUBSCRIBE message. If an “id” parameter is present in the SUBSCRIBE message, that “id” parameter must also be present in the corresponding NOTIFY messages. Event packages may define semantics associated with the body of their NOTIFY requests; if they do so, those semantics apply. NOTIFY bodies are expected to provide additional details about the nature of the event, which has occurred, and the resultant resource state. When present, the body of the NOTIFY request MUST be formatted into one of the body formats specified in the “Accept” header of the corresponding SUBSCRIBE request. This body contains either the state of the subscribed resource or a pointer to such state in the form of a URI.

An event package defines syntax and semantics for SUBSCRIBE method bodies; these bodies typically modify, expand, filter, throttle, and/or set thresholds for the class of events being requested. The NOTIFY body is used to report state on the resource being monitored. Each package must define what type or types of event bodies are expected in NOTIFY requests. Such packages must specify or cite detailed specifications for the syntax and semantics associated with such event bodies. Event packages also must define which Multipurpose Internet Mail Extensions (MIME) type is to be assumed if none are specified in the “Accept” header of the SUBSCRIBE request.

### SUMMARY OF THE INVENTION

In accordance with the present invention, one or more system components participate in a SIP-enabled service discovery protocol. Participation includes using SIP capability to publish, subscribe to, and/or notify of services using: (a) a service description formatted according to a predefined service discovery protocol; and/or (b) a service description query formatted according to the predefined service discovery protocol.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an entity relationship diagram illustrating Service Location Protocol (SLP) components and their interactions in accordance with the prior art;

FIG. 2 is an entity relationship diagram illustrating SLP-based service discovery without a directory agent in accordance with the prior art;

FIG. 3 is an entity relationship diagram illustrating Wide Area Service Location Protocol (WASLP) multicast messages and interactions of Advertising Agents (AAs) and Brokering Agents (BAs) in accordance with the prior art;

FIG. 4 is a flow diagram illustrating Universal Plug and Play (UPnP) phases of operation in accordance with the prior art;

FIG. 5 is a data flow diagram illustrating UPnP device descriptions and interactions with control points in accordance with the prior art;

FIG. 6 is a block diagram illustrating a UPnP protocol stack in accordance with the prior art;

FIG. 7 is an entity relationship diagram illustrating a general architecture of a SIP-based network in accordance with the prior art;

FIG. 8 is a data flow diagram illustrating a subscription/notification mechanism in accordance with the prior art;

FIG. 9 is an entity relationship diagram illustrating device registration with a SIP server and secure symmetric key establishment in accordance with the present invention;

FIG. 10 is a block diagram illustrating service publication using the SIP PUBLISH method in accordance with the present invention;

FIG. 11 is an entity relationship diagram illustrating service discovery through a wide area network in accordance with the present invention;

FIG. 12 is an entity relationship diagram illustrating service discovery using a Light Weight Directory Access Protocol directory service in accordance with the present invention; and

FIG. 13 is a message format diagram illustrating format of a NOTIFY message in accordance with the present invention.

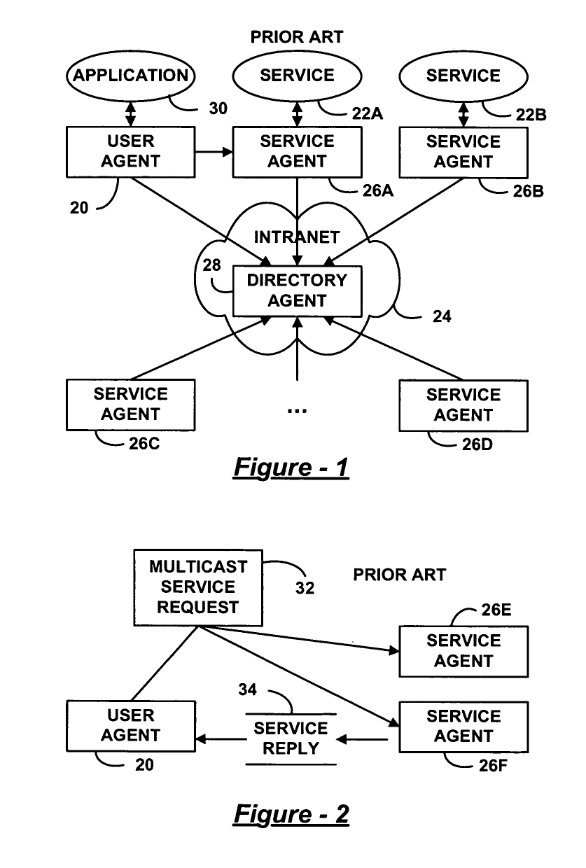

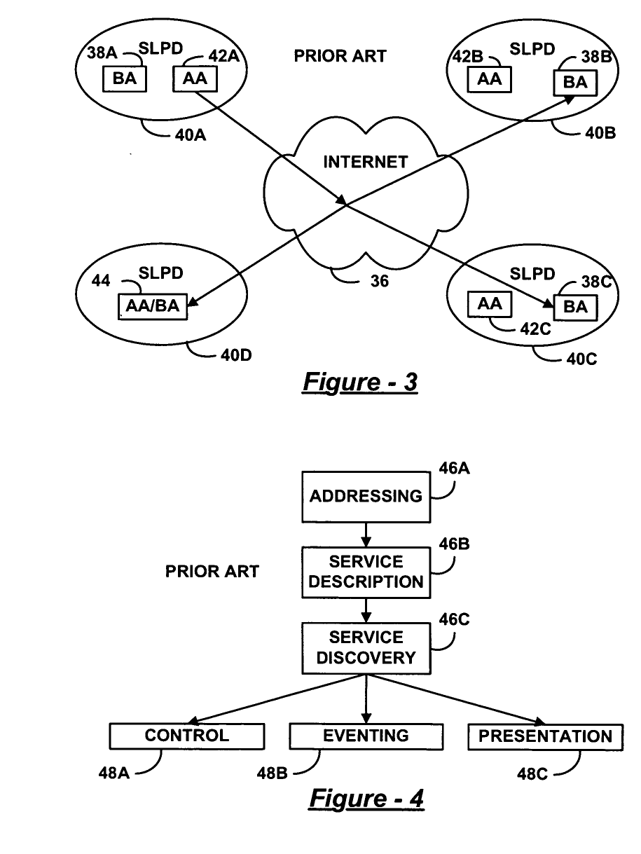

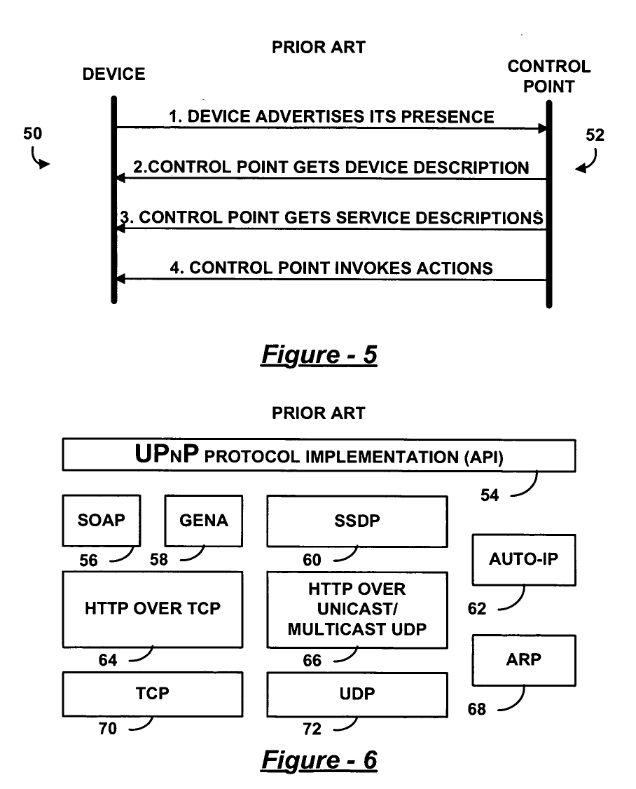

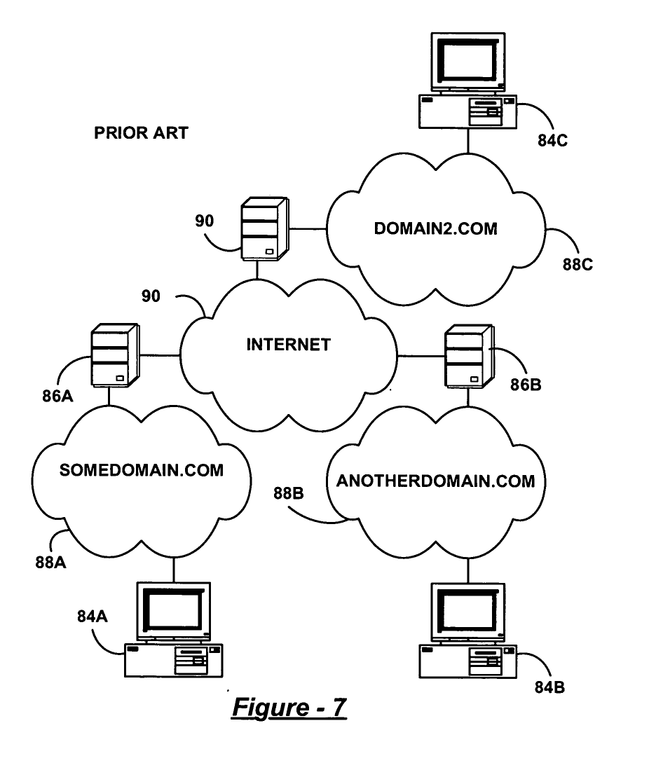

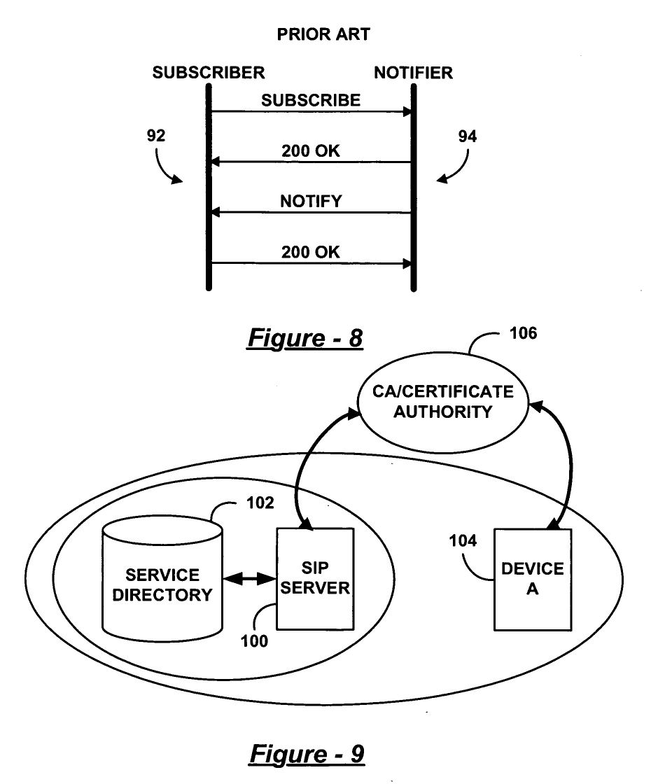

### DETAILED DESCRIPTION OF THE PREFERRED EMBODIMENT

The following description of the preferred embodiment is merely exemplary in nature and is in no way intended to limit the invention, its application, or uses.

As described above, one or more system components participate in a SIP-enabled service discovery protocol. Participation includes using SIP capability to publish, subscribe to, and/or notify of services using: (a) a service description formatted according to a predefined service discovery protocol; and/or (b) a service description query formatted according to the predefined service discovery protocol. The predefined service discovery protocol can be SLP. The system component can be a service providing device, a service subscribing device, and/or a network node. Service subscribing devices can use subscribe and notify components of a SIP event package to send service description queries and obtain service descriptions. Service providing devices can advertise service descriptions using the SIP publish method. Network nodes can propagate service advertisements downstream using SIP publish method, and/or can inform subscribing devices of services using the notify component of the SIP event package.

By way of overview, the present invention provides a mechanism to use SIP for service discovery. Service discovery is an essential step in mobile computing if a user with a wirelessly connected device enters a new environment and wants to use services in the surrounding area. Among all the protocols that have been described for service discovery, SLP (Service Location Protocol) appears to be the most promising one for a number of different reasons. First, SLP is an open standard. Second, the query language of SLP is fairly capable.

SLP allows not only simple matching for equality or prefixes of names, but also comparisons with mathematical operators such as “and”, which is particularly interesting when used with location-based services. This comparison capability is one requirement for query language features employed in service discovery. Using this query language, one can easily search for services within a given area. The proposed scheme according to the present invention extends SLP so that SLP can work in the wide area network. However, even though this proposal uses SLP, it is envisioned that the inventive scheme can be used in conjunction with other service discovery protocols that currently exist in the industry, such as SSDP, SDP, and others mentioned above. Moreover, it is envisioned that future service discovery protocols can be employed.

SLP is intended to function within networks under cooperative administrative control. Such networks permit a policy to be implemented regarding security, multicast routing, and organization of services and clients into groups, which may not be feasible on the scale of the Internet as a whole. SLP has also been designed to serve enterprise networks with shared services, and it may not necessarily scale for wide-area service discovery throughout the global Internet, or in networks where there are hundreds of thousands of clients or tens of thousands of services. By using SIP with SLP, the preferred embodiment of the present invention extends SLP in the wide area network and also minimizes the exposure of a visiting device to the multicast-unicast traffic of service discovery protocols.

Turning to FIG. 9, a network node 100 can be adapted to maintain a knowledge base 102, such as a service directory. Network node 100 can be a SIP server, a proxy server having SIP capability, a home gateway with SIP support, a SIP registrar, and/or any SIP capable network node. Knowledge base 102 can be an SLP directory agent, a JINI lookup table, an LDAP directory, or any datastore of collected service-related information. The collection can be based on advertisements in SLP format received by the SIP Publication method as further explained below. Alternatively or additionally, the collection can be based on advertisements received in accordance with any predefined service discovery protocol, such as SDP, SSDP, or other existing or future service discovery protocols. The network node 100 can provide all of its ordinary functions, such as interfacing with a device 104 in an authenticated manner via certificate authority 106.

A number of options exist for device 104 registration with the network node 100 and secure symmetric key establishment. For example, device 104 can use the SIP publish method to advertise a self-certified certificate. Alternatively, certificate authority 106 can assign a certificate to the device 104. Also, the SIP server 100 can use the SIP SUBSCRIBE/NOTIFY (Identity) mechanism to get the certificate of device 104. Alternatively, other (non-SIP) means can be used. In general, the system components according to the present invention use a public key and private key cryptographic system to establish a shared key, and then use the shared key to encrypt all information exchanged during connection.

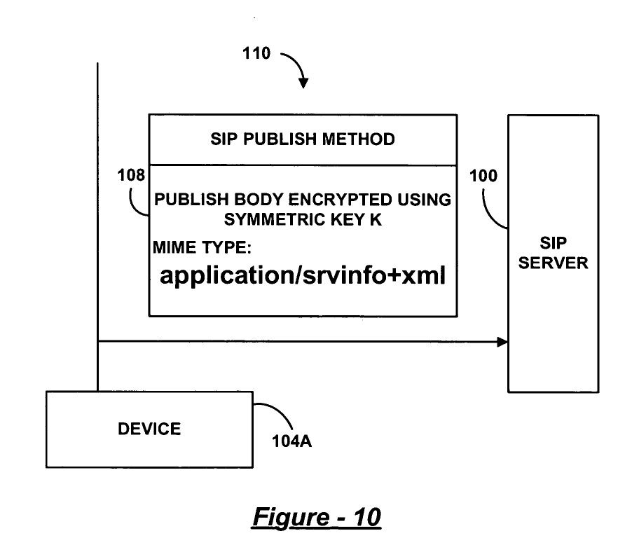

Turning to FIG. 10, a service providing device 104A providing one or more services can publish its service information 108 to and/or through network node 100 via the SIP publish method 110. Mime type content is provided for this purpose as further explained below. This application allows the device 104A to inform the service discovery mechanism of its capabilities in accordance with requirements of the service discovery mechanism. In particular, device 104 can use the SIP REGISTER method to register with a SIP domain registrar of server 100. In this case, S/MIME provides security. As noted above, the REGISTER method can contain a body that in turn contains a symmetric key. This key can be used to carry service discovery information. The body of the REGISTER method can be encrypted using public key cryptography.

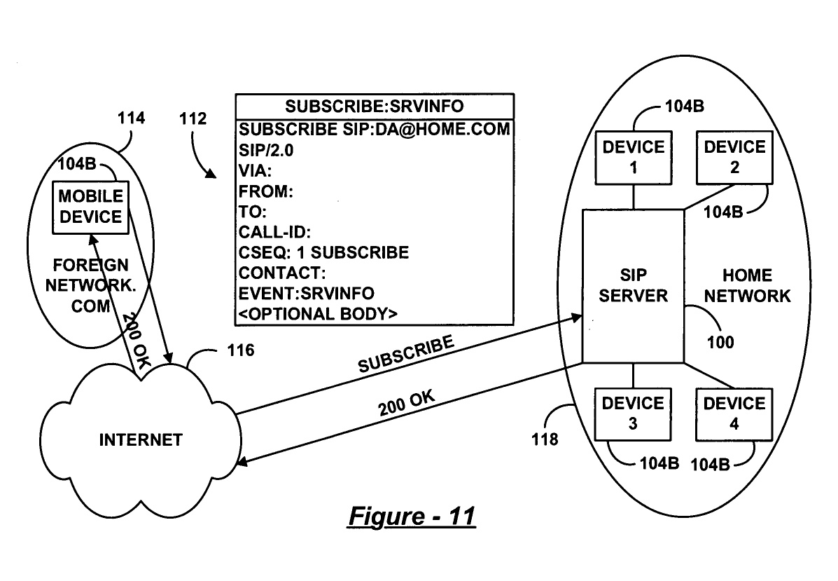

Turning now to FIG. 11, a new SIP specific event package 112 is defined to subscribe for service information. An example of an event package name is: Event: srvinfo. We do not propose to specify any package specific header parameters for this event package. A SUBSCRIBE message for this event package may contain a body. This body can define a filter to apply to the subscription. A specific filter document may or may not be specified in varying embodiments of the present invention. The filter syntax can be derived from the syntax of a predefined service discovery protocol. For example, filter syntax can be derived from SLP query syntax. An example body of a SUBSCRIBE message which is basically an SLP request message is as follows:
<URL>service:printer</URL>
<scope-list>development</scope-list>
<Lang.Tag>en</Lang.Tag>
   Using this event package 112, a subscribing device 104B of a foreign network 114 can subscribe via the Internet 116 to services provided by devices 104A of home network 118 having a network node 100 that is a home gateway.

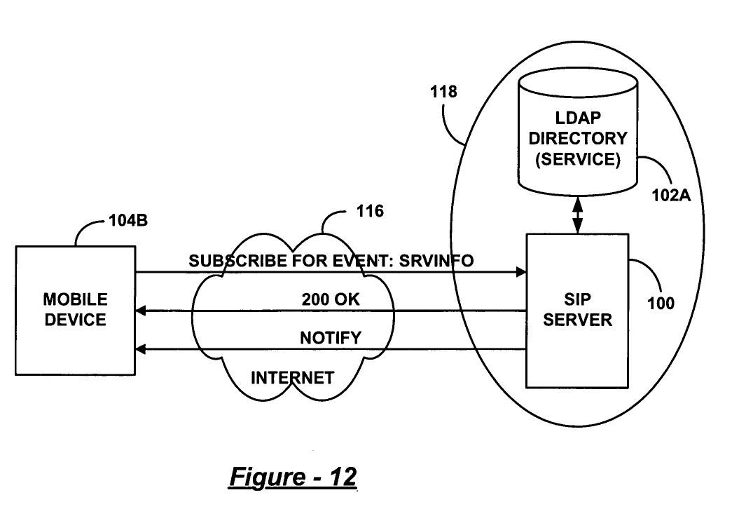

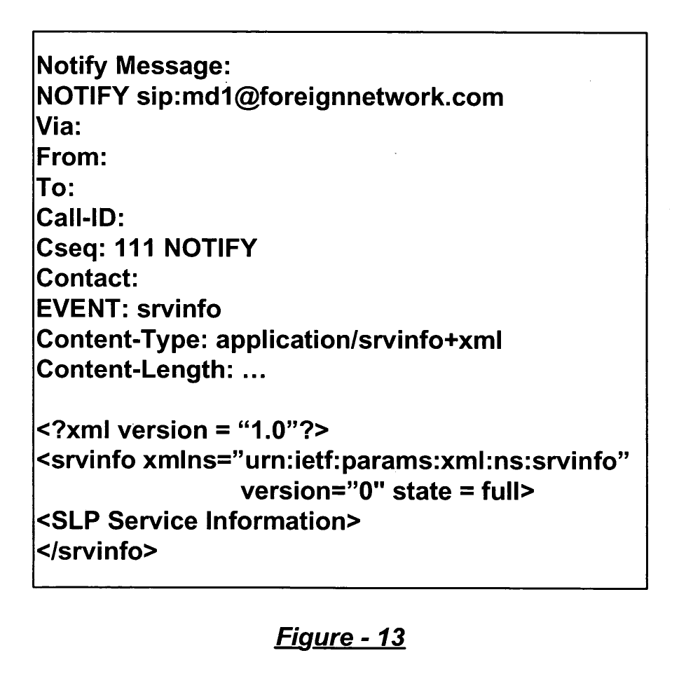

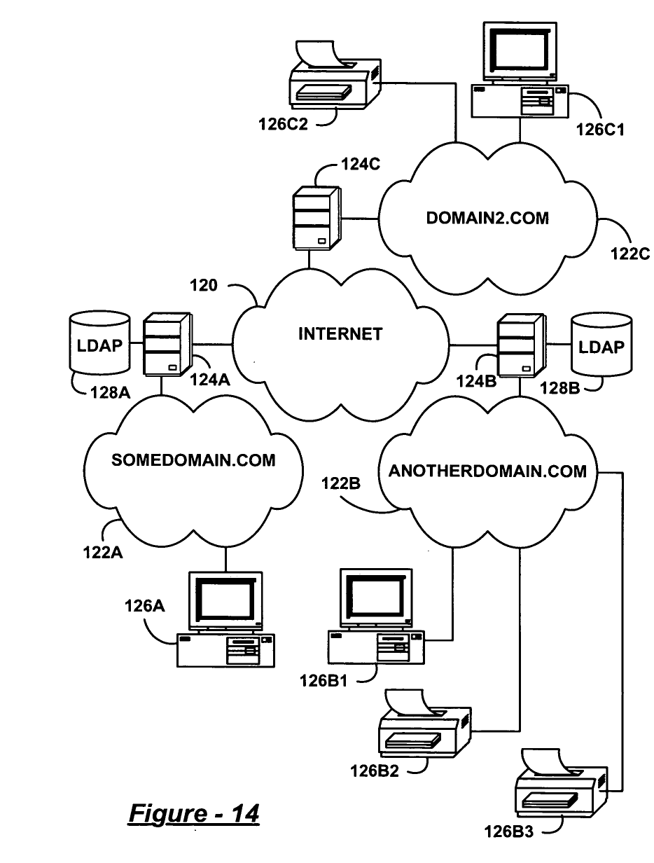

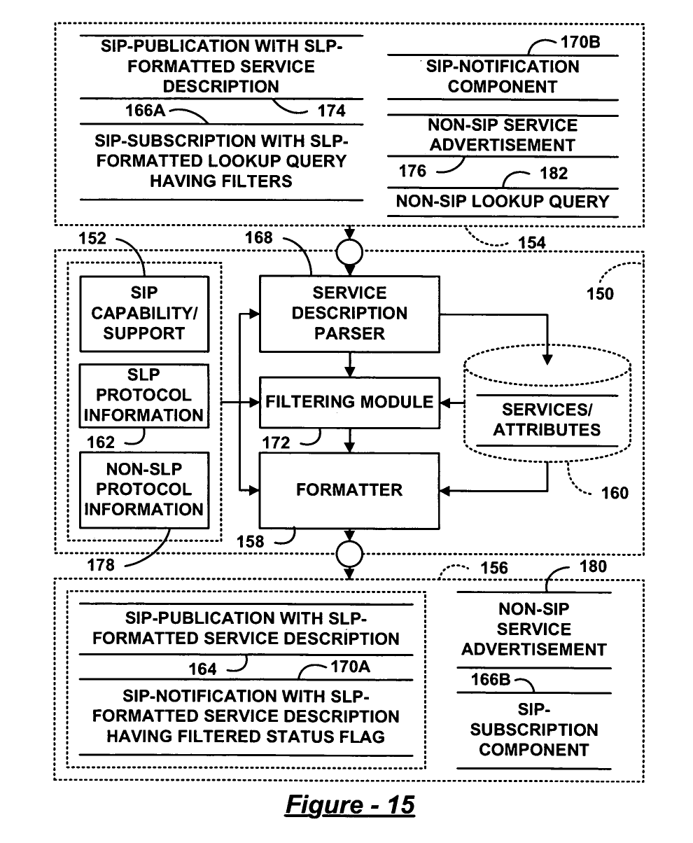

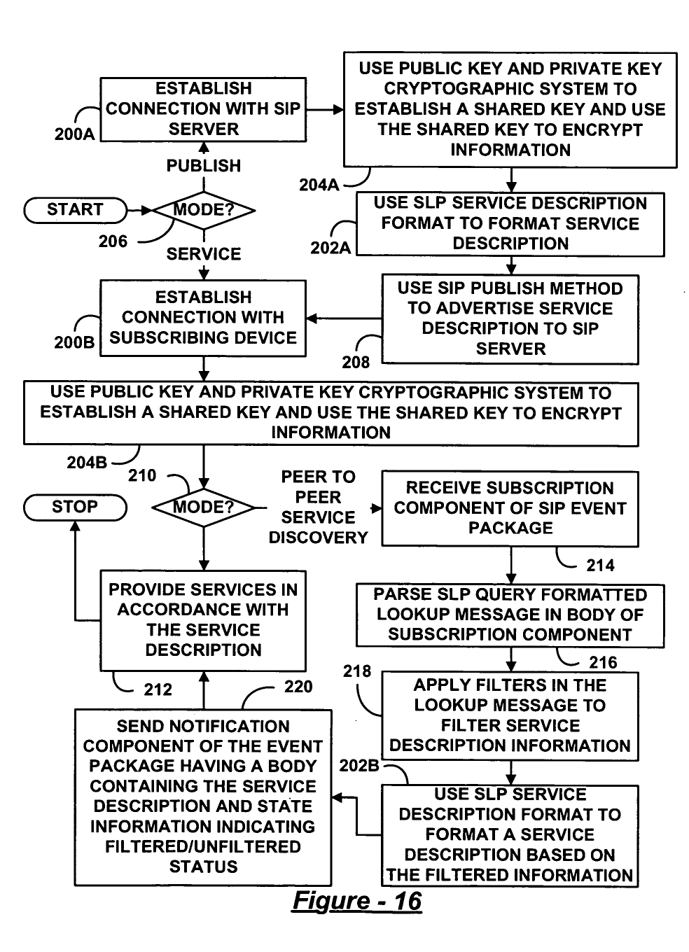

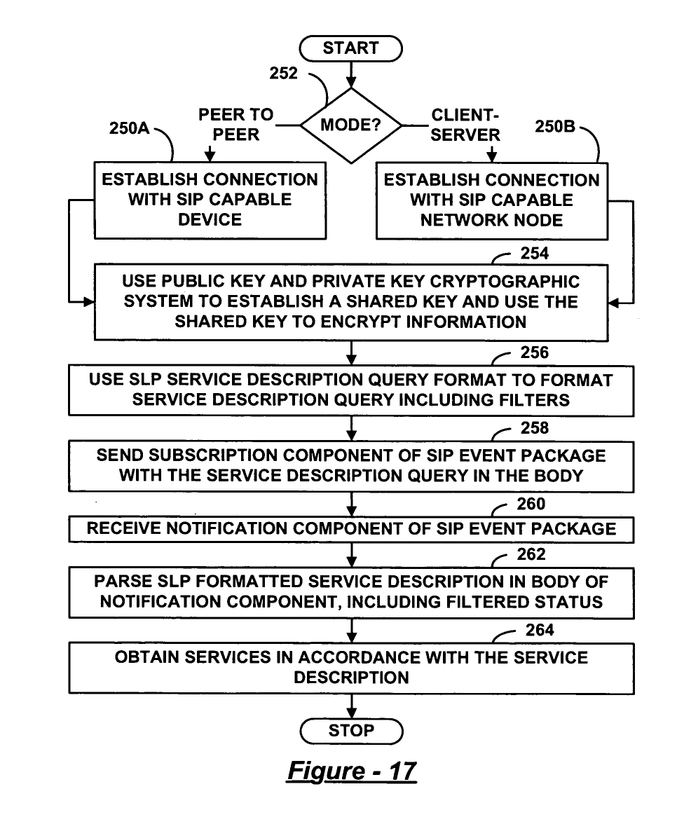

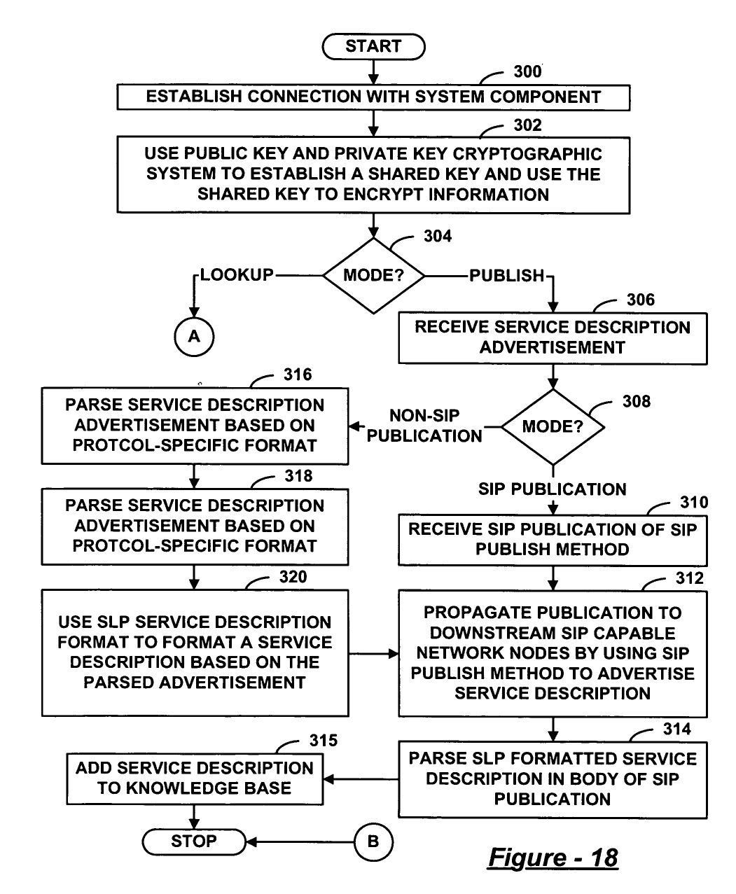

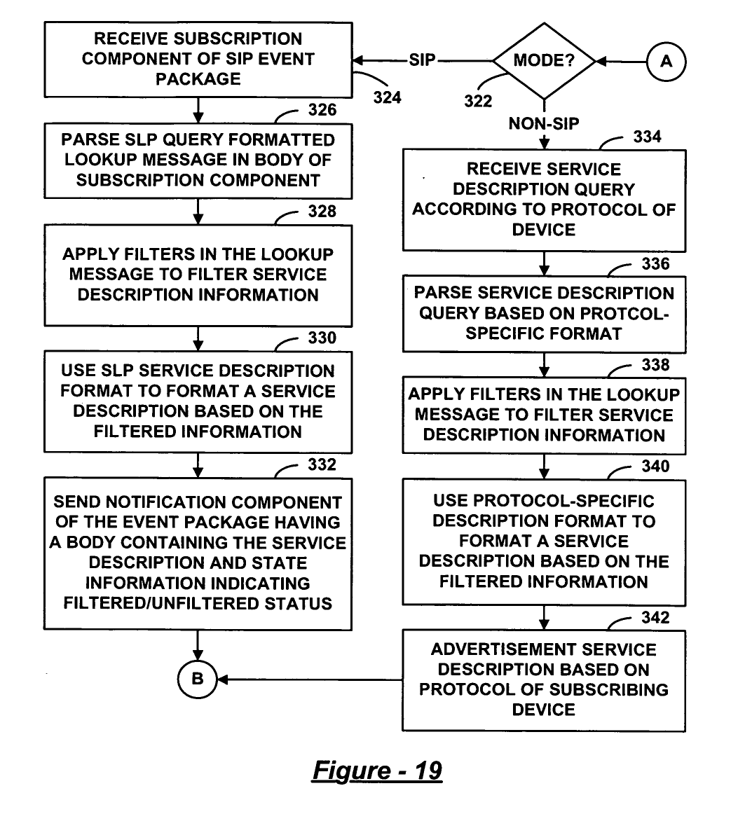

Turning now to FIG. 12, the knowledge base 102 can be an LDAP directory service that collects all of the service information for all of the devices (not shown) of home network 118 publishing their capabilities to SIP server 100 using the Mime type content (not shown) discussed above. Accordingly, when subscribing device 104B subscribes for event: srvinfo, via Internet 116, network node 100 can obtain service information from knowledge base 102 based on the filter information in the subscribe message body. Accordingly, network node 100 can generate a notification that includes the services information in the form of the Mime type content, and can transmit the notification to the subscribing device 104B. The notification can contain state information indicating whether partial of full notification is provided, thus supporting partial notification. An example of the NOTIFY body is provided in FIG. 13. In the proposed scheme of the present invention, we have defined a new MIME type for the NOTIFY body. An example MIME type is as follows:
MIME Type: application/srvinfo+xml
   Accordingly, a SIP capable device is able to discover services without requiring any other service discovery protocol to be implemented in the device.

Turning now to FIG. 14, the system according to the present invention includes one or more system components, such as service providing devices 126B2, 126B3, and 126C2, service subscribing devices 126A, 126B1 and 126C1, and network nodes 124A, 124B, and 124C. However, devices and/or network nodes according to the present invention may have to accommodate other devices and network nodes that do not participate in the SIP-enabled service discovery protocol.

As an example, consider that network nodes 124A and 124B, service providing device 126B2, and service subscribing devices 126A and 126B1 all have SIP capability and participate in the SIP-enabled service discovery protocol according to the present invention, while all other network nodes and devices of FIG. 14 do not. Participating system components can operate with one another in a facilitated manner, while still accommodating non-participating network members. For example, participating subscribing device 126B1 and participating service providing device 126B2 of network domain 122B can operate peer to peer with one another.

Also, participating service providing device 126B2 can advertise its service description to participating network node 124B using SIP publish method. In response, participating network node 124B can store information about the services described in the received publication document in its knowledge base 128B. Additionally, network node 124B can propagate the publication downstream to participating network node 124A, which can respond in kind by adding services information to its knowledge base 128A and further propagating the information downstream as needed. Then, participating subscribing device 126A can subscribe to services information by sending a subscribe component of a SIP event package to participating network node 124A. In response 124A can retrieve services information from its knowledge base 128A based on filters in the subscribe message, and reply with a notification component containing the filtered service information. Accordingly, participating subscribing device 126A of domain 122A can discover participating service providing device 126B2 and obtain its services in accordance with the service description.

Further, participating network nodes can provide service discovery to participating service subscribing devices of services provided by non-participating service providing devices. For example, non-participating service providing device 126B3 can have a predefined service discovery capability, and can advertise its service description in accordance with its particular protocol to participating network node 124B. In response, network node 124B can interpret the advertisement, translate it into another format in accordance with another predefined service discovery protocol, add information relating to the advertised services to its knowledge base 128B, and propagate services-related information downstream to participating network node 124A using SIP publish method. Accordingly, participating subscribing devices 126A and 126B1 can discover services provided by non-participating device 126B3 by sending subscribe components to and receiving notification components form participating network nodes 124A and 124B, respectively.

Yet further, participating network nodes 122A and 122B can receive and process advertisements over the Internet 120 from non-participating network node 124C, and/or non-participating subscribing device 126C1, both of domain 122C. As a result, participating subscribing devices 126A and 126B1 can discover services provided by non-participating device 126C2 in the same way as services provided by non-participating device 126C3 and participating device 126C2 are discovered. Moreover, participating network nodes 124A and 124B can use other predefined service discovery protocols, such as WASRV, to advertise its collected service information downstream to non-participating network node 122C and/or non-participating subscribing device 126C1.

Turning now to FIG. 15, the participating system component 150 according to the present invention can be a service providing device, a service subscribing device, and/or a network node. Accordingly, the system component according to the present invention can exhibit various sub-components. One sub-component possessed by all system components according to the present invention is SIP capability 152, or equivalently SIP support. Inputs 154, outputs, 156, and other subsystem components can vary depending on device function. However, it should be readily understood that some participating system components, such as a home gateway that can have built in service providing capability, may multiple functions. For example, such a gateway can function as a participating network node, a participating service providing device, and even as a participating service subscribing device. As a result, some participating system components according to the present invention can have all of the inputs 154, outputs 156, and various subcomponents depicted in FIG. 15, or various sub-sets thereof.

Consider, for example, that the system component 150 is a service providing device adapted to establish connection with another system component having SIP capability 152, and use service description formatter 158 to format a service description based on contents of service description information datastore 160 according to information 162 about a predefined service description format of a predefined service discovery protocol, such as SLP. If the other participating system component is a network node, then a SIP publication 164 can be generated and sent in accordance with SIP publish method, with the service description contained in the SIP publication.

If the other participating device is a subscribing device, then the participating system component 150 can receive a subscription component 166A of a SIP event package from the other system component, use service description parser 168 to parse a lookup message in the subscription component, and send a notification component 170A of the SIP event package to the other device. The lookup message can be in a predefined query format of the predefined service discovery protocol, while the notification component 170A can contain a service description formatted by formatter 158. Component 150 can use filtering module 172 to apply filters in the lookup message to filter service description information of datastore 160, so that formatter 158 generates the service description based on filtered information obtained by application of the filters. The notification component 170A can contain a flag indicating the filter status of the service description contained in the notification 170.

Also, consider the case where system component 150 is a network node adapted to establish connection with another system component, either participating or non-participating. Additionally, consider the case where the other system component is a service providing device, and the system component 150 receives a service description advertisement as a SIP publication 174, and/or as a non-SIP advertisement 176. Such a system component 150 is able to use parser 168 to parse service descriptions in the received advertisements 174 and 176 using information 172 about the predefined service discovery protocol, and/or using information 178 about other predefined service discovery protocols. The parsed information can be added to datastore 160, which in this case serves as a knowledge base. Alternatively or additionally, formatter 158 can reformat the parsed information, and the reformatted information can be added to datastore 160. The system component 150 is also able to propagate information relating to the service descriptions received in the advertisements 174 and 176 downstream to other participating network nodes using SIP publish method in the form of SIP publication 174. This publication 174 can be a forwarded version of advertisement 174, or can be a reformatted version of advertisement 176. Some embodiments of such a system component 150 can send out non-SIP service advertisements 180 to non-participating downstream network nodes and/or subscribing devices by forwarding advertisement 176, and/or by reformatting advertisements 174 and 176 according to information 178 and sending out non-SIP advertisements 180 accordingly.

Still considering the case where the system component 150 is a network node, further consider the sub-case where the other system component is a subscribing device. In this case, the system component 150 can respond to received subscription components 166A in a manner similar to that described above respective of the case where system component 150 is a service providing device. operating peer to peer with a subscribing device. Additionally, some embodiments of system component 150 as a network node can receive a non-SIP lookup query 182 and, using information 162 and/or 178, respond with a non-SIP service advertisement 180 based on contents of datastore 160, which can have been collected from SIP advertisements 174 and/or non-SIP advertisements 176.

Further, consider the case where the system component 150 is a service subscribing device establishing connection with another system component having SIP capability, such as a network node or service providing device. In this case, system component 150 uses formatter 158 to formulate a lookup query based on information 162, and send a subscription component 166B of a SIP event package to the other system component that contains the lookup query. In response, the system component receives a 170B, uses parser 168 to parse a service description contained in the notification component based on information 162, and obtain services in accordance with the service description.

In each of the above cases, the system components preferably use a public key and private key cryptographic system to establish a shared key with another system component, and use the shared key to encrypt one or more of service description information and service description query information.

Turning now to FIGS. 16-19, the method of operation for the system component according to the present invention includes participating in a SIP-enabled service discovery protocol, including using SIP capability to one or more of publish, subscribe to, and notify of a service using one or more of: (a) a service description formatted according to a predefined service discovery protocol; and (b) a service description query formatted according to the predefined service discovery protocol. However, the method of operation can vary based on function of the system component, and based on function or mode of operation of another system component communicating with the system component. In particular, the method can take at least three forms, including a method of operation for a service providing device illustrated in FIG. 16, a method of operation for a service subscribing device illustrated in FIG. 17, and a method of operation for a network node illustrated in FIGS. 18-19. It should be readily understood that a system component can have multiple functions, such that steps of the methods in FIGS. 16-19 can be combined in various ways.

Referring to FIG. 16 the method of operation for a service providing device includes establishing connection with another system component having SIP capability at steps 200A and 200B, and formatting a service description according to a predefined service description format of the predefined service discovery protocol, such as SLP, at steps 202A and 202B. Following and/or during establishment of connection with either a network node at step 200A or a service subscribing device at step 200B, the public key and private key cryptographic system is used to establish a shared key at steps 204A and 204B, which is then used to encrypt all subsequently exchanged information. If the service providing device is operating in a publication mode as at 206, then the SIP publish method is used to advertise the service description to the network node at step 208.

During a servicing mode of operation as at 206, and following connection to a subscribing device at step 200B, further operation depends on whether the subscribing device has already obtained the service information from a network node as at 210. If so, the method concludes with providing services in accordance with the service description at step 212. If not, the method enters a peer to peer service discovery mode that includes receiving a subscription component of a SIP event package from the subscribing device at step 214, and parsing a lookup message in the subscription component at step 216. The lookup message is in a predefined query format of the predefined service discovery protocol, such as SLP. Peer to peer service discovery further includes sending a notification component of the SIP event package to the other device at step 220. The notification component contains the service description formatted at step 202B and generated from information filtered at step 218 by applying filters in the lookup message to filter service description information. Then, the method concludes with providing services at step 212.

Referring now to FIG. 17, the method of operation for a subscribing device according to the present invention includes establishing connection with another system component having SIP capability at steps 250A and 250B. Whether communication is established with a network node at step 250B or a service providing device at step 250A depends on whether the device is operating in a client-server mode or a peer-to-peer mode as at 252. The public key and private key cryptographic system is used to establish a shared key at step 254, which is then used to encrypt all subsequently exchanged information. Then, a predefined service description query format of a predefined service discovery protocol, such as SLP, is used to format a service description query at step 256, including filters relating to the type of service desired. Next, a subscription component of a SIP event package is sent to the other system component at step 258. The subscription component contains the service description query. Then, a notification component of the SIP event package is received at step 260, and a service description contained in the notification component is parsed at step 262 according to the predefined service discovery protocol. Finally, services are obtained in accordance with the service description at step 264. It should be readily understood that a client-server mode of operation ends after step 262, and a peer-to-peer mode of operation begins in step 264 in which the subscribing device establishes communication with the service providing device and obtains services.

Referring now to FIG. 18, the method of operation for a network node includes establishing connection with another system component at step 300, which may or may not be a participating system component. The public key and private key cryptographic system is used to establish a shared key at step 302, which is then used to encrypt all subsequently exchanged information. If the network node is operating in a publishing mode as at 304, then a service description advertisement is received at step 306. If the advertisement is published in accordance with SIP publish method as at 308, then the publication is propagated downstream to other network nodes using SIP publish method. Otherwise, the service description of the advertisement is parsed at step 316 based on its protocol-specific format, and the service description is reformatted at step 318 according to a predefined service description protocol, such as SLP, to obtain a new service description. This new service description can then be propagated downstream at step 316 using the SIP publish method. The SLP formatted service description is parsed at step 314 and added to a knowledge base at step 316.

Turning now to FIG. 19, if the network node is operating in a lookup mode as at 304, then further processing depends on whether SIP lookup is being performed, or non-SIP lookup as at 322. According to SIP lookup mode, the network node receives a subscription component of a SIP event package from a subscribing device at step 324, and parses a lookup message in the subscription component at step 326. The lookup message is in a predefined service description query format of the predefined service discovery protocol, such as SLP. Filters specified in the lookup message are applied to filter service description information at step 328, and a service description is generated at step 330 from filtered information obtained by application of the filters. At step 332, a notification component of the SIP event package is sent to the subscribing device. The notification component contains a service description formatted according to a predefined service description format of the predefined service discovery protocol, such as SLP.

If non-SIP lookup is being performed as at 322, then a service description query is received at step 334 according to a protocol of the subscribing device, such as UPnP. Then, upon detection of the format, the network node parses the query based on the detected format at step 336. Next, filters in the lookup message are applied to filter service information at step 338, and a service description generated from the filtered information is formatted based on the detected format at step 340. Finally, the service description is advertised to the device in accordance with the detected format at step 342.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A system, comprising:
at least one system component having SIP capability and adapted to participate in a SIP-enabled service discovery protocol by using the SIP capability to one or more of publish, subscribe to, and notify of a service using one or more of:
(a) a service description formatted according to a predefined service discovery protocol; and
(b) a service description query formatted according to the predefined service discovery protocol.

2. The system of claim 1, wherein said system component is a service providing device adapted to establish connection with another system component having SIP capability, and format a service description according to a predefined service description format of the predefined service discovery protocol.

3. The method of claim 2, wherein said service providing device is adapted to receive a subscription component of a SIP event package from the other system component, parse a lookup message in the subscription component, and send a notification component of the SIP event package to the other device, wherein the lookup message is in a predefined query format of the predefined service discovery protocol, the notification component contains the service description, and the other system component is a subscribing device.

4. The system of claim 3, wherein said service providing device is adapted to apply filters in the lookup message to filter service description information, and generate the service description based on filtered information obtained by application of the filters.

5. The system of claim 2, wherein said service providing device is adapted to use SIP publish method to advertise the service description to the other system component, wherein the other system component is a network node.

6. The system of claim 1, wherein said system component is a network node adapted to establish connection with another system component; receive a service description advertisement, and propagate information relating to the service description downstream to other network nodes using SIP publish method.

7. The system of claim 6, wherein said network node is adapted to parse a service description of the advertisement according to a second predefined service description format of a second predefined service discovery protocol, format a new service description based on a first predefined service description format of the predefined service discovery protocol, and add information relating to the service description to a knowledge base.

8. The system of claim 1, wherein said system component is a network node adapted to establish connection with another system component having SIP capability that is a subscribing device, receive a subscription component of a SIP event package from the subscribing device, parse a lookup message in the subscription component, and send a notification component of the SIP event package to the subscribing device, wherein the lookup message is in a predefined service description query format of the predefined service discovery protocol, and the notification component contains a service description formatted according to a predefined service description format of the predefined service discovery protocol.

9. The system of claim 8, wherein said network node is adapted to apply filters in the lookup message to filter service description information, and generate the service description based on filtered information obtained by application of the filters.

10. The system of claim 1, wherein said system component is a service subscribing device adapted to establishing connection with another system component having SIP capability, use a predefined service description query format of the predefined service discovery protocol to format a service description query, send a subscription component of a SIP event package to the other system component, receive a notification component of the SIP event package, parse a service description contained in the notification component according to the predefined service discovery protocol, and obtain services in accordance with the service description, wherein the subscription component contains the service description query.

11. The system of claim 1, wherein the predefined service discovery protocol is SLP.

12. The system of claim 1, wherein said system component is adapted to use a public key and private key cryptographic system to establish a shared key with another system component, and use the shared key to encrypt one or more of service description information and service description query information.

13. A method of operation for a system component, comprising:
participating in a SIP-enabled service discovery protocol, including using SIP capability to one or more of publish, subscribe to, and notify of a service using one or more of:
(a) a service description formatted according to a predefined service discovery protocol; and
(b) a service description query formatted according to the predefined service discovery protocol.

14. The method of claim 13, wherein participating in the SIP-enabled service discovery protocol includes acting in a service providing capacity.

15. The method of claim 14, further comprising:
establishing connection with another system component having SIP capability; and
formatting a service description according to a predefined service description format of the predefined service discovery protocol.

16. The method of claim 15, further comprising:
receiving a subscription component of a SIP event package from the other system component;
parsing a lookup message in the subscription component, wherein the lookup message is in a predefined query format of the predefined service discovery protocol; and
sending a notification component of the SIP event package to the other device, wherein the notification component contains the service description, and the other system component is a subscribing device.

17. The method of claim 16, further comprising applying filters in the lookup message to filter service description information, wherein formatting the service description includes generating the service description based on filtered information obtained by application of the filters.

18. The method of claim 16, wherein the predefined service discovery protocol is SLP.

19. The method of claim 15, further comprising using SIP publish method to advertise the service description to the other system component, wherein the other system component is a network node.

20. The method of claim 15, wherein the predefined service discovery protocol is SLP.

21. The method of claim 13, wherein participating in the SIP-enabled service discovery protocol includes acting in a network node capacity.

22. The method of claim 21, further comprising:
establishing connection with another system component;
receiving a service description advertisement; and
propagating information relating to services advertised in the advertisement downstream to other network nodes using SIP publish method.

23. The method of claim 21, further comprising:
parsing a service description of the advertisement according to a second predefined service description format of a second predefined service discovery protocol; and
formatting a new service description based on a first predefined service description format of the predefined service discovery protocol.

24. The method of claim 21, further comprising adding information relating to advertised services to a knowledge base.

25. The method of claim 23, wherein the first predefined service discovery protocol is SLP.

26. The method of claim 21, further comprising:
establishing connection with another system component having SIP capability that is a subscribing device;
receiving a subscription component of a SIP event package from the subscribing device; and
parsing a lookup message in the subscription component, wherein the lookup message is in a predefined service description query format of the predefined service discovery protocol.

27. The method of claim 26, further comprising sending a notification component of the SIP event package to the subscribing device, wherein the notification component contains a service description formatted according to a predefined service description format of the predefined service discovery protocol.

28. The method of claim 27, further comprising;
applying filters specified in the lookup message to filter service description information; and
generating the service description based on filtered information obtained by application of the filters.

29. The method of claim 28, wherein the predefined service discovery protocol is SLP.

30. The method of claim 27, wherein the predefined service discovery protocol is SLP.

31. The method of claim 13, wherein participating in the SIP-enabled service discovery protocol includes acting in a service subscribing capacity.

32. The method of claim 31, further comprising:
establishing connection with another system component having SIP capability;
using a predefined service description query format of the predefined service discovery protocol to format a service description query; and
sending a subscription component of a SIP event package to the other system component, wherein the subscription component contains the service description query.

33. The method of claim 32, further comprising:
receiving a notification component of the SIP event package;
parsing a service description contained in the notification component according to the predefined service discovery protocol; and
obtaining services in accordance with the service description.

34. The method of claim 33, wherein the predefined service discovery protocol is SLP.

35. The method of claim 13, wherein the predefined service discovery protocol is SLP.

36. The method of claim 13, further comprising using a public key and private key cryptographic system to establish a shared key with another system component.

37. The method of claim 36, further comprising using the shared key to encrypt service description information.
